(19) United States
(12) Patent Application Publication
(10) Pub. No.: US 2019/0188118 A1
(43) Pub. Date: Jun. 20, 2019

(54) SYSTEM AND METHOD FOR GENERATING DATABASE INDEPENDENT INPUT TEST DATA

(71) Applicants: Vijay Musku, Bangalore (IN); Hanamanth Pujari, Bangalore (IN)

(72) Inventors: Vijay Musku, Bangalore (IN); Hanamanth Pujari, Bangalore (IN)

(73) Assignee: Unisys Corporation, Blue Bell, PA (US)

(21) Appl. No.: 15/884,735

(22) Filed: Jan. 31, 2018

(30) Foreign Application Priority Data
Dec. 15, 2017 (IN) 201711045127

(51) Int. Cl. G06F 11/36; G06F 17/30

(52) U.S. Cl. CPC G06F 11/3684; G06F 17/30569; G06F 11/3688

(57) ABSTRACT

A system and method for generating database independent input test data. The system includes a source database having an input and an output, a plurality of target databases each having an input and an output, a test data generator coupled to the input of the source database, and a data exchanger coupled between the output of the source database and the input of each of the target databases. The test data generator generates input test data that is database independent, and sends the generated input test data to the source database. The source database sends the input test data to the data exchanger. The data exchanger transforms the input test data into a database format compatible with at least one of the plurality of target databases. The data exchanger sends the transformed input test data to the target database for which the transformed input test data is compatible.

### BACKGROUND

### Field

The instant disclosure relates to test data generation, and in particular to systems and methods for generating database independent input test data.

### Description of the Related Art

Generating input test data for database applications is a relatively important part of database application testing. Generating such input test data is important because the generated input test data is used for database acceptance testing, security testing, performance testing, error-handling testing and stress/load testing in production-like conditions, which allows for users to see test-condition behavior of a database comparable to what will be seen in production environments. As such, the generated input test data should be as realistic and meaningful as possible so that database testing results are as close as possible to production environment results. Generating realistic input test data also allows database features to be more readily demonstrated and understood. Generating realistic input test data also makes database applications more robust, and allows for possible errors to be found more readily.

Test data generation for database applications involves creating an arrangement of input test data or other information for testing various database software and hardware applications. The generated test data can be real information that has been taken from past operations. Alternatively, the generated test data can be artificial data created for a particular database application testing purpose.

In general, database test data generation is seen as a relatively complex issue. Conventional database test data generation systems and methods typically are directed or restricted to relatively small database applications. More specifically, conventional database test data generation systems and methods are database specific, i.e., conventional database test data generation systems and methods generate data for a specific database. Therefore, test data generated by conventional database test data generation systems and methods are not database independent. Accordingly, conventional database test data generation systems and methods can be used only for those databases for which the generated test data is compatible.

There is a need for database test data generators, systems and methods that generate test data that is database independent.

### SUMMARY

Disclosed is a system and method for generating database independent input test data. The system includes a source database having an input and an output. The system also includes a plurality of target databases, each having an input and an output. The system also includes a test data generator coupled to the input of the source database. The system also includes a data exchanger coupled between the output of the source database and the input of each of the target databases. The test data generator generates input test data that is database independent, and sends the generated input test data to the source database. The source database sends the input test data to the data exchanger. The data exchanger transforms the input test data into a database format compatible with at least one of the plurality of target databases. The data exchanger sends the transformed input test data to the target database for which the transformed input test data is compatible.

### BRIEF DESCRIPTION OF THE DRAWINGS

FIG. 1 is a schematic view of a conventional system for generating database input test data;

FIG. 2 is a schematic view of a system for generating database independent input test data, according to an embodiment;

FIG. 3 is a schematic view of a test data generator used in a system for generating database independent input test data, according to an embodiment; and

FIG. 4 is a flow diagram of a method for generating database independent input test data, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

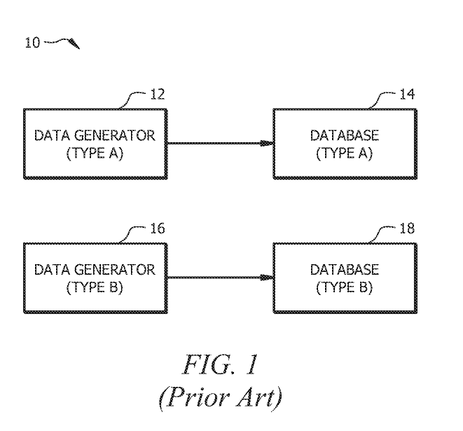

FIG. 1 is a schematic view of a conventional system 10 for generating database input test data. The conventional system 10 includes a first data generator 12 for generating input test data for a first target database 14. In the conventional system 10, the first data generator 12 must be compatible with the first target database 14. That is, if the first target database 14 is a “type A” database, then the first data generator 12 is a “type A” data generator, which generates “type A” input test data that is compatible only with “type A” databases. For example, if the first target database 14 is an SQL (structure query language) database, then the first data generator 12 is compatible with SQL databases, i.e., the first data generator 12 generates input test data that is compatible only with SQL databases.

If the conventional system 10 includes a second target database 18 that is a “type B” database, then the conventional system 10 also needs to include a second “type B” data generator 16 that is compatible with “type B” databases. In this case, the second “type B” data generator 16 is a data generator that generates “type B” input test data that is compatible only with “type B” databases. For example, if the second target database 18 is an ORACLE database, then the second data generator 16 is compatible with ORACLE databases, i.e., the second data generator 16 generates input test data that is compatible only with ORACLE databases.

As discussed hereinabove, conventional systems for generating database input test data are limited in their application, as conventional systems for generating database input test data include one or more data generators that each are specific to only one type of target database. For example, in the conventional system 10 shown in FIG. 1, the first “type A” data generator 12 can only be used to generate input test data for “type A” target databases, e.g., the first “type A” target database 14. The first “type A” data generator 12 cannot be used to generate input test data for any other type of database, such as a “type B” target database, e.g., the second “type B” target database 18. Similarly, the second “type B” data generator 16 can only be used to generate input test data for “type B” target databases, e.g., the second “type B” target database 18. The second “type B” data generator 16 cannot be used to generate input test data for any other type of database, such as a “type A” target database, e.g., the first “type A” target database 14. Therefore, in a conventional system that includes both “type A” and “type B” databases, the conventional system must include at least two separate data generators, a “type A” data generator and a “type B” data generator.

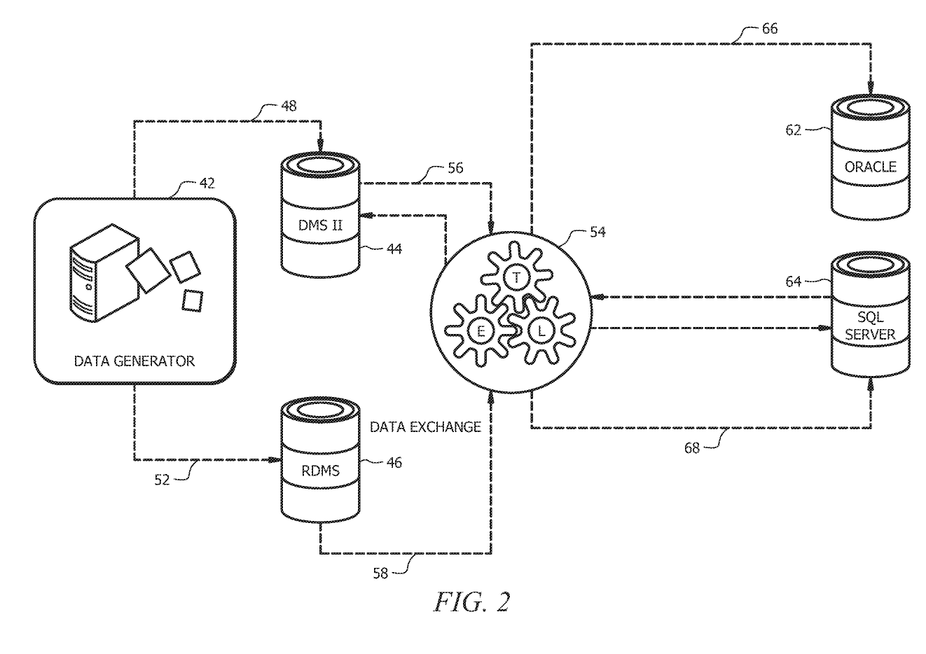

FIG. 2 is a schematic view of a system 40 for generating database independent input test data, according to an embodiment. The system 40 is characterized by the ability to transform database input test data from one type of database input test data into database input test data that is compatible with another type of database. Accordingly, the system 40 greatly benefits from the ability to generate input test data that is database independent.

The system 40 includes a test data generator 42 for generating database input test data. The test data generator 42 is database independent, and is capable of generating input test data suitable for more than one type of database, as will be discussed in greater detail hereinbelow.

The system 40 also includes one or more source databases, e.g., a first source database 44, such as a Unisys DMSII (Data Management System II) database, and a second source database 46, such as a Unisys RDMS (Relational Data Server) database. The test data generator 42 is coupled to an input of the first source database 44 (shown as a connection 48). The test data generator 42 also is coupled to an input of the second source database 46 (shown as a connection 52).

The system also includes a data exchange component, element or module (i.e., data exchanger) 54 coupled to an output of each source database. For example, the data exchanger 54 is coupled to an output of the first source database 44 (shown as a connection 56). Also, the data exchanger 54 is coupled to an output of the second source database 46 (shown as a connection 58).

The system 40 also includes a plurality of target databases, e.g., a first target database 62, such as an ORACLE target database, and a second target database 64, such as an SQL database. The output of the data exchanger 54 is coupled to an input of each target database. For example, the output of the data exchanger 54 is coupled to an input of the first target database 62 (shown as a connection 66). The output of the data exchanger 54 also is coupled to an input of the second target database 64 (shown as a connection 68).

It should be understood that any one of the one or more source databases can be any suitable database, e.g., a Unisys DMSII database, a Unisys RDMS database, an ORACLE database, an SQL database, or other suitable database. Also, it should be understood that any one or more of the plurality of target databases can be any suitable database, e.g., a Unisys DMSII database, a Unisys RDMS database, an ORACLE database, an SQL database, or other suitable database.

One or more of the test data generator, the source databases, the target databases and the data exchanger can be a standalone component or machine, or can be a component within a larger standalone component or machine. Also, it should be understood that more than one of the test data generator, the source databases, the target databases and the data exchanger can be part of the same standalone component or machine. Regardless of the particular configuration of the test data generator, the source databases, the target databases and the data exchanger, it should be understood that the relationships between the test data generator, the source databases, the target databases and the data exchanger the source database 12 and the target database 14 are machine-to-machine connections, and involves machine-to-machine communications, i.e., the exchange of data between machines. For example, the data generator 42 and the data exchanger 54 can be separate host components, and the one or more source databases can be a third host component, or part of a third host component, coupled between the data generator 42 and the data exchanger 54 host components. Also, one or more source databases and one or more target databases can be separate host components, and the data exchanger can be a third host component, or part of a third host component, coupled between the source database and the target database host components.

As discussed hereinabove, the test data generator 42 is database independent, and can generate input test data suitable for more than one type of database. The test data generator 42 obtains various information about the various sources databases and the various target databases. Such information can include data formats used in the target databases, supported data types used in the target databases, database ranges supported by the data types used in the target databases, and other suitable information related to the target databases.

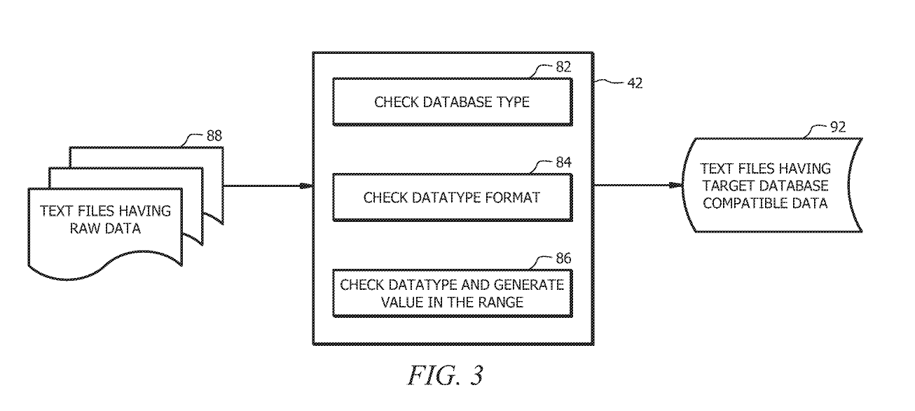

FIG. 3 is a schematic view of the test data generator 42 used in a system for generating database independent input test data, according to an embodiment. The test data generator 42 includes a database check (Check Database Type) component 82. The database check component 82 determines, via user input, for which database or databases the test data generator 42 is going to generate test data. That is, the database check component 82 determines, via user input, which database or databases are going to be target databases.

The test data generator 42 also includes a DataType format check (Check DataType Format) component 84. The DataType format check component 84 determines the data format compatibility of the supported data types used in the target database(s). The DataType format varies from database to database. The DataType format check component 84 determines the data format compatibility of the supported data types used in the target database(s) based on user input.

The test data generator 42 also includes a DataType range check (Check DataType Range) component 86. The DataType range check component 86 determines the boundary values of the supported data types used in the target database(s) and the range values of the supported data types used in the target database(s).

Once the test data generator 42 has obtained suitable information about the various target databases, including data formats, supported data types, data boundary values and data ranges values, the test data generator 42 generates appropriate input test data based on the obtained information. For example, based on the data formats, the supported data types used in the target databases, the database boundary values of the supported data types used in the target database, and the data range values of the supported data types used in the target databases, the test data generator 42 generates input test data as an unstructured text file or “flat” file 92 according to column data types, column delimiters and row delimiters.

According to an embodiment, the test data generator 42 also may receive text files having raw data (shown generally text files 88), which the test data generator 42 uses along with the obtained information described hereinabove to generate input test data as an unstructured text file or “flat” file 92. Alternatively, the test data generator 42 generates input test data as an unstructured text file or “flat” file 92 without having received any raw data text files 88.

Once the test data generator 42 has generated the input test data in a flat file, the test data generator 42 sends the generated input test data to one or more source databases, where the flat file data is inserted into the database table of the source database. For example, the test data generator 42 sends the generated input test data to the first source databases 44 via the connection 48 and to the second source database 46 via the connection 52. The source databases then pass the generated input test data to the data exchanger 54.

The data exchanger 54 is configured to transform received input test data from the current database format of the input test data into any one of a number of other database formats. Accordingly, the ability of the data exchanger 54 to transform input test data from one database format to another database format allows the data exchanger 54 to receive input test data from one or more of the source databases and transform that received input test data from the source database format into one or more target database formats. Once the data exchanger 54 has transformed the input test data into the appropriate target database format, the data exchanger 54 sends the transformed input test data to the appropriate target database.

For example, input test data received by the data exchanger 54 from the first source database 44 is in a Unisys DMSII-compatible database format. If the immediate target database is the first target database 62, i.e., an ORACLE database, the data exchanger 54 transforms the input test data from a Unisys DMSII-compatible database format to an ORACLE-compatible database format. The data exchanger 54 then sends the transformed input test data to the first target database 62, i.e., an ORACLE database. The input test data received by the first target database 62 is in an ORACLE-compatible database format, and therefore is suitable for use in testing by the ORACLE database.

Depending on from which source database the data exchanger 54 receives input test data, and depending on which target database the data exchanger 54 is to send transformed input test data, any number of input test data transformations can occur. For example, input test data received by the data exchanger 54 can be transformed from a Unisys DMSII-compatible database format to an ORACLE-compatible database format, from a Unisys DMSII-compatible database format to an SQL-compatible database format, from a Unisys RDMS-compatible database format to an ORACLE-compatible database format, or from a Unisys RDMS-compatible database format to an SQL-compatible database format. It should be understood that other input test data transformations can occur, depending on the compatibility of the source database and the target database.

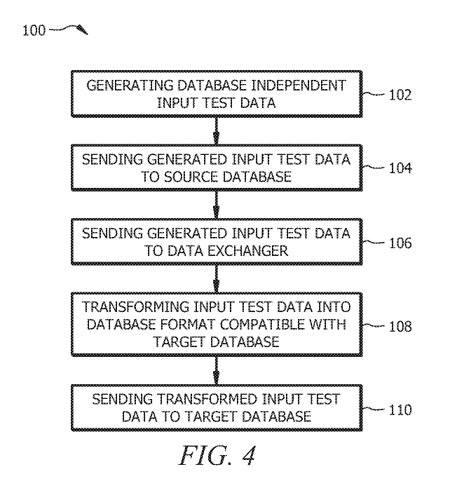

FIG. 4 is a flow diagram of a method 100 for generating database independent input test data, according to an embodiment. The method 100 includes a step 102 of generating input test data that is database independent. As discussed hereinabove, the test data generator 42 generates input test data that is database independent.

The method 100 also includes a step 104 of sending the generated input test data to one or more of the source databases 44, 46. As discussed hereinabove, the test data generator 42 sends the generated input test data to one or more of the source databases 44, 46.

The method 100 also includes a step 106 of sending the input test data to the data exchanger 54. As discussed hereinabove, one or more of the source database 44, 46 sends the input test data to the data exchanger 54.

The method 100 also includes a step 108 of transforming the input test data into a database format compatible with one of the target databases 62, 64. As discussed hereinabove, the data exchanger 54 transforms the input test data into a database format compatible with one of the target databases 62, 64.

The method 100 also includes a step 110 of sending the transformed input test data to the target database for which the transformed input test data is compatible. As discussed hereinabove, the data exchanger 54 sends the transformed input test data to the target database 62, 64 for which the transformed input test data is compatible.

It will be apparent to those skilled in the art that many changes and substitutions can be made to the embodiments described herein without departing from the spirit and scope of the disclosure as defined by the appended claims and their full scope of equivalents.

1. A system for generating database independent input test data, the system comprising:
at least one source database having an input and an output;
a plurality of target databases, wherein the plurality of target databases includes a first target database and at least one second target database, wherein each target database includes an input and an output;
a test data generator coupled to the input of the at least one source database; and
a data exchanger coupled between the output of the at least one source database and the input of each of the plurality of target databases,
wherein the test data generator generates input test data that is database independent,
wherein the test data generator sends the generated input test data to the at least one source database,
wherein the at least one source database inserts the received generated input test data into a database table of the at least one source database,
wherein the at least one source database sends the database table having the generated input test data therein to the data exchanger,
wherein the data exchanger transforms the input test data in the database table of the at least one source database into a database format compatible with at least one of the plurality of target databases, and
wherein the data exchanger sends the transformed input test data to the target database for which the transformed input test data is compatible.

2. The system as recited in claim 1, wherein the test data generator obtains database information for the at least one source database and the plurality of target databases, wherein the test data generator generates input test data based on the obtained database information, and wherein the input test data generated by the test data generator is database independent.

3. The system as recited in claim 2, wherein the database information includes one or more data formats used in at least one of the plurality of target databases, one or more supported data types used in at least one of the plurality of target databases, data format compatibility of one or more of the supported data types used in at least one of the plurality of target databases, boundary values of one or more of the supported data types used in at least one of the plurality of target databases, and range values of one or more of the supported data types used in at least one of the plurality of target databases.

4. The system as recited in claim 1, wherein the test data generator includes a database check component, wherein the database check component determines for which databases of the plurality of target databases the test data generator is going to generate input.

5. The system as recited in claim 1, wherein the test data generator includes a DataType format check component, wherein the DataType format check component determines one or more data formats used in at least one of the plurality of target databases, one or more supported data types used in at least one of the plurality of target databases, and data format compatibility of one or more of the supported data types used in at least one of the plurality of target databases.

6. The system as recited in claim 1, wherein the test data generator includes a DataType range check component, wherein the DataType range check component determines boundary values of one or more of the supported data types used in at least one of the plurality of target databases, and range values of one or more of the supported data types used in at least one of the plurality of target databases.

7. The system as recited in claim 1, wherein the test data generator generates input test data in the form of a flat file.

8. The system as recited in claim 1, wherein the at least one source database is one of a Unisys DMSII database and a Unisys RDMS database.

9. The system as recited in claim 1, wherein the plurality of target databases includes an ORACLE database and an SQL database.

10. A method for generating database independent input test data, the method comprising:
generating input test data that is database independent;
sending the generated input test data to at least one source database;
inserting the generated input test data into a database table of the at least one source database;
sending the database table having the generated input test data therein to a data exchanger;
transforming the input test data into a database format compatible with at least one of the plurality of target databases; and
sending the transformed input test data to the target database for which the transformed input test data is compatible.

11. The method as recited in claim 10, further comprising obtaining database information for the at least one source database and for at least one of the plurality of target databases, and wherein the generated input test data is generated based on the obtained database information.

12. The method as recited in claim 10, wherein the database information includes one or more data formats used in at least one of the plurality of target databases, one or more supported data types used in at least one of the plurality of target databases, data format compatibility of one or more of the supported data types used in at least one of the plurality of target databases, boundary values of one or more of the supported data types used in at least one of the plurality of target databases, and range values of one or more of the supported data types used in at least one of the plurality of target databases.

13. The method as recited in claim 10, wherein the generated input test data is in the form of a flat file.

14. The method as recited in claim 10, wherein the at least one source database is one of a Unisys DMSII database and a Unisys RDMS database.

15. The method as recited in claim 1, wherein the plurality of target databases includes an ORACLE database and an SQL database.

16. A test data generator for generating database independent input test data, the test data generator comprising:
a database check component, wherein the database check component determines for which databases of the plurality of target databases the test data generator is going to generate input;
a DataType format check component, wherein the DataType format check component determines one or more data formats used in at least one of the plurality of target databases, one or more supported data types used in at least one of the plurality of target databases, and data format compatibility of one or more of the supported data types used in at least one of the plurality of target databases; and
a DataType range check component, wherein the DataType range check component determines boundary values of one or more of the supported data types used in at least one of the plurality of target databases, and range values of one or more of the supported data types used in at least one of the plurality of target databases,
wherein the test data generator generates input test data that is database independent.

17. The test data generator as recited in claim 16, wherein the test data generator obtains database information for the at least one source database and the plurality of target databases, wherein the test data generator generates input test data based on the obtained database information, and wherein the input test data generated by the test data generator is database independent.

18. The test data generator as recited in claim 16, wherein the database information includes one or more data formats used in at least one of the plurality of target databases, one or more supported data types used in at least one of the plurality of target databases, data format compatibility of one or more of the supported data types used in at least one of the plurality of target databases, boundary values of one or more of the supported data types used in at least one of the plurality of target databases, and range values of one or more of the supported data types used in at least one of the plurality of target databases.

19. The test data generator as recited in claim 16, wherein the test data generator generates input test data in the form of a flat file.
